(19) United States
(12) Patent Application Publication
(10) Pub. No.: US 2025/0299318 A1
(43) Pub. Date: Sep. 25, 2025

(54) IMAGE INSPECTION DEVICE

(71) Applicant: Keyence Corporation, Osaka (JP)

(72) Inventors: Keisuke FUKUTA, Osaka (JP); Yuichiro HIDA, Osaka (JP)

(73) Assignee: Keyence Corporation, Osaka (JP)

(21) Appl. No.: 19/049,074

(22) Filed: Feb. 10, 2025

(30) Foreign Application Priority Data
Mar. 19, 2024 (JP) 2024-043898

(51) Int. Cl. G06T 7/00; G06V 10/764

(52) U.S. Cl. CPC G06T 7/0006; G06V 10/764; G06T 2207/20081

(57) ABSTRACT

An image inspection device includes an image capturing section that generates a plurality of frame images aligned in time series, an inspection execution section that executes inspection processing of an object appearing in the plurality of frame images by a machine learning model to output an inspection result, and an inspection setting section that performs setting of the inspection execution section. The machine learning model includes a feature extraction section, and a determination section that outputs the inspection result from the feature amount. The inspection setting section receives selection of a first image, and determines a threshold. The inspection execution section outputs an inspection trigger when it is determined that the threshold is present between a first score based on a feature amount extracted from the first frame image and a second score based on a feature amount extracted from the second frame image.

### CROSS-REFERENCE TO RELATED APPLICATIONS

The present application claims foreign priority based on Japanese Patent Application No. 2024-043898, filed Mar. 19, 2024, the contents of which are incorporated herein by reference.

### BACKGROUND OF THE INVENTION

### 1. Technical Field

The present disclosure relates to an image inspection device.

### 2. Description of the Related Art

An image sensor of related art generally executes detection processing of an object on one frame image (see, for example, JP2022-164146A).

### SUMMARY OF THE INVENTION

Incidentally, in a case where image inspection is performed on a moving object, it is necessary to acquire, as an inspection target image, a frame image captured at a timing when the object is in a desired state (position, angle, or the like) in a capturing field of view.

In a case where the position or the angle of the object deviates in the capturing field of view, a position or an angle of an inspection target region can be adjusted by a “position correction tool” disclosed in JP2022-164146A. However, adjustment cannot be performed unless a reference position of the “position correction tool” and the inspection target region are included in a captured frame image of an inspection target in the first place.

Accordingly, when the image inspection is performed on the moving object, the accuracy of the image inspection depends on whether or not an appropriate trigger timing is given to the image sensor. However, setting of an external device so as to give the appropriate trigger timing to the image sensor takes a time and effort of a user. Thus, a configuration in which an inspection trigger is output when frame images sequentially acquired by the image sensor satisfy a predetermined trigger condition and the inspection is executed on a captured frame image (=inspection target image) at a timing specified based on the inspection trigger has been known.

However, in a case where the trigger condition is severe, the inspection for the image to be inspected may be missed. For example, in a case where the trigger condition is severe enough to satisfy only a non-defective product of the object, there may be a problem that the inspection trigger is not applied when the object is a defective product. Conversely, in a case where the trigger condition is loose, the inspection is executed on an image that should not be the inspection target, and an unnecessary image inspection result can be acquired. For example, in a case where the inspection that outputs an OK determination as a quality determination for the object when a target image is the non-defective product image is executed as the inspection executed by the trigger, there may be a problem that an image that should not be an inspection target is an image having no object and thus is determined as a defective product image, and an NG determination is output even though the object of the defective product is not detected.

As described above, in the image sensor of the related art, it is difficult to set the trigger condition such that the inspection trigger is output at the timing desired by the user. Note that, even in a configuration in which a region for determination is set in a part of the capturing field of view or in a configuration in which the object is searched for from the capturing field of view, it is difficult to set a loose or abrupt trigger condition as long as the setting is based on rules, and thus a similar problem may occur.

In view of the above problems, the present disclosure provides an image inspection device capable of setting a flexible trigger condition.

An image inspection device according to one embodiment includes an image capturing section that continuously captures a capturing field of view to generate a plurality of frame images aligned in time series, an inspection execution section that executes inspection processing of an object appearing in the plurality of frame images by a machine learning model to output an inspection result, and an inspection setting section that performs setting of the inspection execution section. The machine learning model includes a feature extraction section that extracts a feature amount from the frame image, and a determination section that outputs the inspection result from the feature amount, the inspection setting section receives selection of a first image, and determines a score calculation method based on a first feature amount extracted from the selected first image such that a score based on the first feature amount satisfies a predetermined relative relationship with respect to a threshold, and the inspection execution section extracts the feature amount from a first frame image and a second frame image continuous with the first frame image, as the plurality of frame images, and outputs an inspection trigger when it is determined that the threshold is present between a first score based on a feature amount extracted from the first frame image and a second score based on a feature amount extracted from the second frame image.

Note that, other characteristics, elements, steps, advantages, and features will be more apparent from the following detailed description and the accompanying drawings.

The image inspection device according to the present disclosure can set the flexible trigger condition.

### BRIEF DESCRIPTION OF THE DRAWINGS

FIG. 1 is a diagram for describing an image inspection device according to an embodiment of the invention at the time of an operation;

FIG. 2 is a hardware configuration diagram of the image inspection device;

FIG. 3 is a functional block diagram of the image inspection device;

FIG. 4 is a diagram illustrating a setting flow of an AI trigger tool; and

FIG. 5 is a diagram illustrating a graphical user interface [GUI] transition of FIG. 4.

### DETAILED DESCRIPTION

Hereinafter, embodiments of the invention will be described in detail with reference to the drawings. Note that, the following description of preferred embodiments is merely exemplary in nature and is not intended to limit the invention, an application thereof, or an intended use thereof.

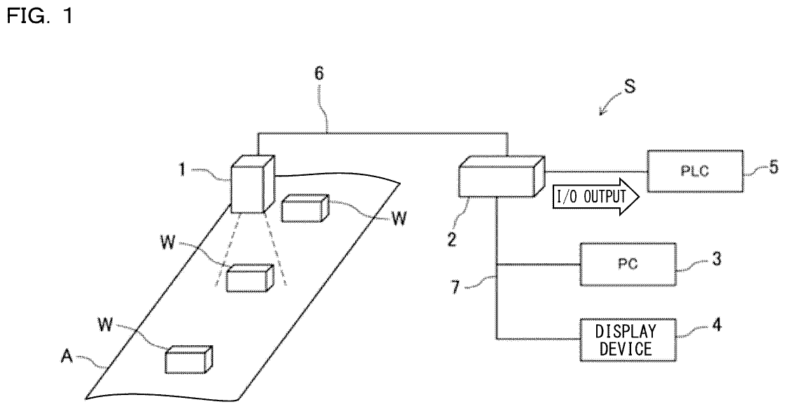

FIG. 1 is a diagram for describing an image inspection device S according to an embodiment of the invention at the time of an operation. For example, the image inspection device S captures workpieces W conveyed by a conveyance unit A according to capturing settings to acquire inference image data, detects the workpieces W in images of the acquired inference image data, and outputs a detection result to an external device. Examples of the external device include a programmable logic controller (PLC) 5 and the like, but a device other than the PLC 5 may be an external device. Based on the received detection result, the PLC 5 controls the conveyance unit A so as to separate storage destinations of the workpieces W, for example. In the following description, a case where the external device is the PLC 5 will be described. Note that, the workpiece W may be a workpiece that is not conveyed by the conveyance unit A. In addition, in the following description, the workpiece is also referred to as an object.

The image inspection device S includes an image capturing unit 1 for capturing an image of the workpiece W, a control unit 2 to which inference image data captured by the image capturing unit 1 is input, a personal computer (PC) 3 for performing settings and the like of the image inspection device S, and a display device 4 for displaying a setting screen, a selection screen, a workpiece image, a detection result, and the like. In the control unit 2, a trained model for detecting the workpiece W in the image of the input inference image data is executable. The control unit 2 executes an output corresponding to the detection result by the trained model for the PLC 5.

Here, the image inspection device S may be used, for example, when the workpiece W is inspected from various angles at each point of a manufacturing apparatus or a manufacturing line. Thus, a plurality of image inspection devices S may be installed in one manufacturing apparatus or one manufacturing line, and it is conceivable that an installation space and a power supply cannot be sufficiently secured. Accordingly, the image inspection device S needs miniaturization corresponding to the installation space and power saving corresponding to the power supply, and in order to satisfy these needs, the image inspection device S according to the present embodiment does not include a graphics processing unit (GPU). The control unit 2 can execute a trained model in which learning is performed to such an extent that the workpiece W can be detected, but a vendor provides the image inspection device to a user such that desired detection accuracy can be obtained even though the user does not perform advanced machine learning that is recommended to use the GPU. Since the user does not need to perform advanced machine learning, the user can execute a trained model capable of detecting the workpiece W without preparing a GPU suitable for learning. In addition, a time taken by the user to prepare the trained model capable of detecting the workpiece W can be shortened. Note that, one image inspection device S may be installed and operated in a manufacturing apparatus or a manufacturing line. In addition, the image inspection device S can also be referred to as an image sensor.

### (Configuration of Image Capturing Unit)

The image capturing unit 1 is separate from the control unit 2, and is installed so as to be able to capture the workpiece W from a desired direction. The workpiece W is sequentially conveyed by the conveyance unit A to a capturing field of view of the image capturing unit 1.

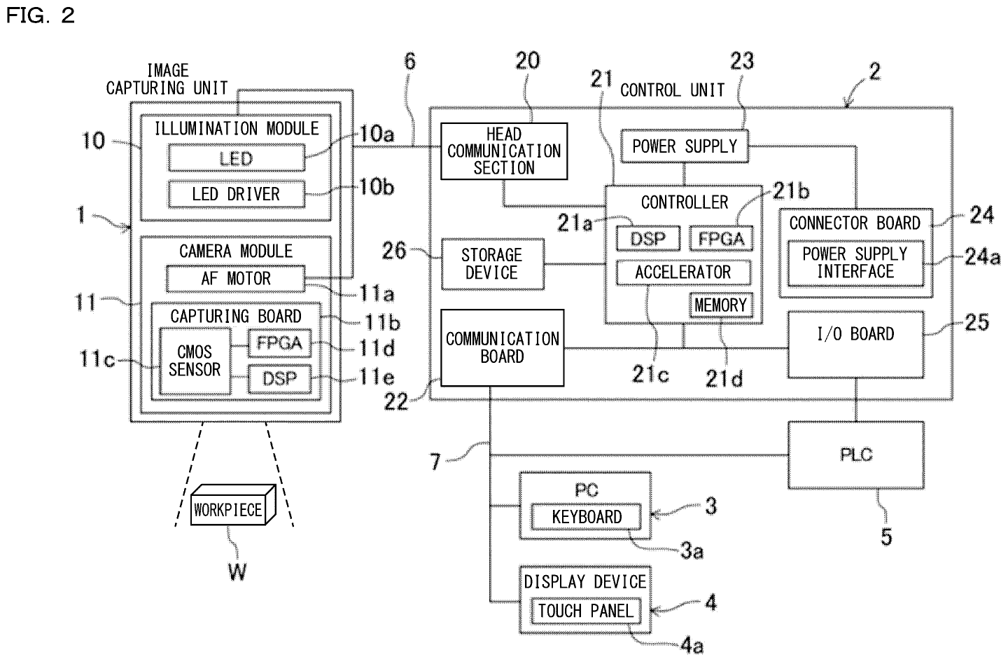

FIG. 2 is a hardware configuration diagram of the image inspection device S. As illustrated in FIG. 2, the image capturing unit 1 includes an illumination module 10 for illuminating the workpiece W and a camera module 11 for capturing an image of the workpiece W illuminated by the illumination module 10.

The illumination module 10 includes a light emitting diode (LED) 10a that irradiates the workpiece W with light, and an LED driver 10b that controls a light amount, a light emission timing, and the like of the LED 10a. The LED driver 10b is connected to a head communication section 20 (to be described later) of the control unit 2, and is controlled by a controller 21 (to be described later) of the control unit 2.

The camera module 11 includes an AF motor 11a and a capturing board 11b. The AF motor 11a is a member for automatically focusing on the workpiece W by driving a focusing lens of an optical system (not illustrated). The autofocusing method is not particularly limited, and examples thereof include a contrast method and the like.

The capturing board 11b includes a CMOS sensor 11c, an FPGA 11d, and a DSP 11c. The CMOS sensor 11c is an image sensor that receives reflected light emitted from the LED 10a to the workpiece W and reflected by the workpiece W. The CMOS sensor 11c is connected to the head communication section 20 of the control unit 2, and is controlled by the controller 21 of the control unit 2 to perform exposure processing at a predetermined timing for a predetermined time.

The FPGA 11d is a processing device capable of changing internal processing contents. The DSP 11e is a signal processing device. A light reception amount signal of a light receiving element included in the CMOS sensor 11c is output to the FPGA 11d and processed, and is also output to the DSP 11e and processed. The processing by the FPGA 11d and the DSP 11e is not particularly limited, and examples thereof include various kinds of filter processing. Image data processed by the FPGA 11d and the DSP 11e is transmitted from the image capturing unit 1 to the control unit 2.

The image capturing unit 1 and the control unit 2 are connected via a communication cable 6. Thus, the control unit 2 can be installed at a place away from an installation place of the image capturing unit 1.

### (Configuration of PC)

The PC 3 is constituted by a general-purpose personal computer or the like. In this example, the PC 3 can be used by installing a predetermined program in a personal computer. The PC 3 includes operation devices such as a keyboard 3a and a mouse (not illustrated). The user of the image inspection device S can perform a setting operation and a selection operation of the image inspection device S by operating the operation device of the PC 3. Specific setting operation and selection operation will be described later.

The PC 3 and the communication board 22 of the control unit 2 are connected to communicate with each other, and information based on the setting operation by the user is transmitted from the PC 3 to the control unit 2. In addition, the PC 3 can receive the image data of the workpiece W, the inspection result, and the like output from the control unit 2. The PC 3 and the control unit 2 are connected via a communication cable 7. Thus, the PC 3 can be installed at a place away from an installation place of the control unit 2.

### (Configuration of Display Device 4)

The display device 4 includes, for example, a liquid crystal display, an organic EL display, or the like. In this example, the display device 4 includes a touch panel 4a. The touch panel 4a is a member capable of detecting an operation by a user's finger. A type of the touch panel 4a is not particularly limited, and examples thereof include a capacitance type and an infrared type. The display device 4 and the communication board 22 of the control unit 2 are connected to communicated with each other. Operation information of the touch panel 4a by the user is transmitted from the display device 4 to the control unit 2. In addition, the display device 4 can receive image data and the like of the workpiece W output from the control unit 2. The display device 4 and the control unit 2 are connected via the communication cable 7. Thus, the display device 4 can be installed at a place away from the installation place of the control unit 2.

Note that, the PC 3 and the display device 4 may be integrally provided. For example, the display device 4 may be constituted by a display device included in the PC 3. In this case, a body portion of the PC 3 and the display device 4 may be integrated with each other or may be separated from each other. In addition, in this example, the communication board 22 and the PLC 5 are connected via the communication cable 7.

### (Configuration of Control Unit 2)

As illustrated in FIG. 2, the control unit 2 includes the head communication section 20, the controller 21, the communication board 22, a power supply 23, a connector board 24, an I/O board 25, and a storage device (storage section) 26. The head communication section 20 is a portion that is connected to the controller 21 and executes communication between the controller 21 and the image capturing unit 1. A control signal of the image capturing unit 1 output from the controller 21 is transmitted to the image capturing unit 1 via the head communication section 20. The control signal of the image capturing unit 1 includes a signal for controlling a light emission timing and a light emission amount of the LED 10a and a signal for controlling the AF motor 11a and the capturing board 11b. In addition, the image data acquired by the image capturing unit 1 is output from the image capturing unit 1 and is then transmitted to the controller 21 via the head communication section 20.

The controller 21 includes a DSP 21a and an FPGA 21b that execute various kinds of signal processing, an accelerator 21c for speeding up processing, and a memory 21d including a RAM, a ROM, and the like. A specific configuration of the controller 21 will be described later.

The communication board 22 is a member that is connected to the controller 21 and executes communication between the controller 21, the PC 3, the display device 4, and the PLC 5.

The connector board 24 includes a power supply interface 24a. A power cable (not illustrated) for supplying power from an outside is connected to the power supply interface 24a. The connector board 24 and the power supply 23 are connected, and power supplied from the outside to the power supply interface 24a is adjusted to a predetermined voltage by the power supply 23 and is then supplied to the controller 21. The power supplied to the controller 21 is supplied to the image capturing unit 1 via the head communication section 20.

The I/O board 25 is connected to the controller 21. The inspection result output from the controller 21 is input to the PLC 5 via the I/O board 25.

### (Functional Block)

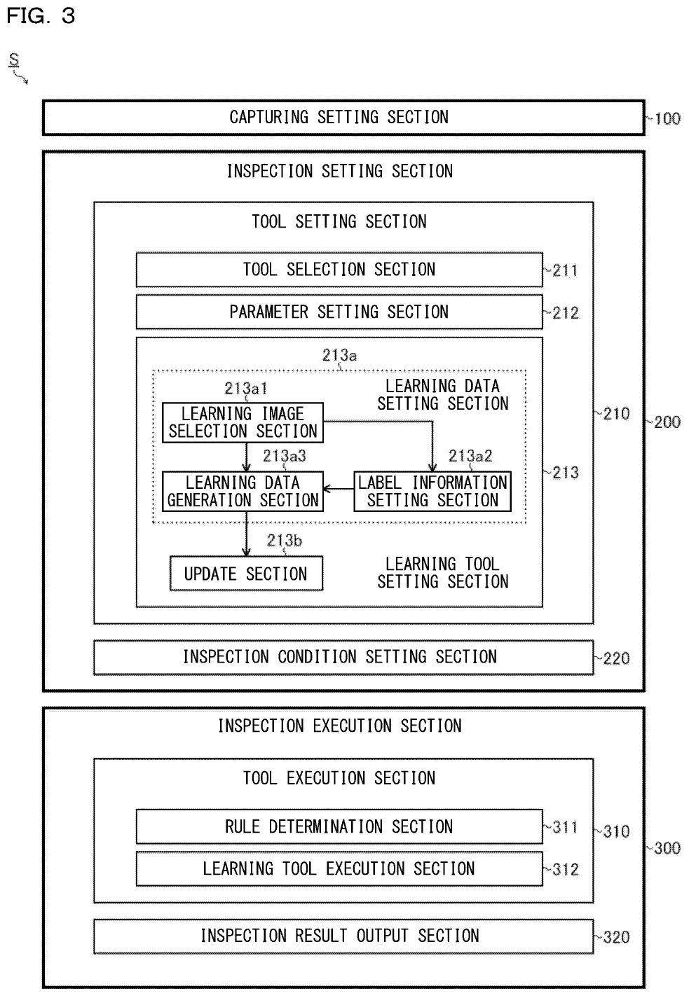

FIG. 3 is a functional block diagram of the image inspection device S. As illustrated in this drawing, the image inspection device S includes, as functional blocks thereof, a capturing setting section 100, an inspection setting section 200, and an inspection execution section 300.

The capturing setting section 100 performs various settings (capturing field of view, brightness of image, focus, capturing interval (frame rate), and the like) regarding a capturing operation of the image capturing unit 1. Note that, the image capturing unit 1 can be understood as an image capturing section that continuously captures the capturing field of view to generate a plurality of frame images FR aligned in time series.

The inspection setting section 200 performs various settings regarding the inspection of the frame image FR by the inspection execution section 300. In accordance with this drawing, the inspection setting section 200 includes a tool setting section 210 and an inspection condition setting section 220.

The tool setting section 210 sets various tools. In accordance with this drawing, the tool setting section 210 includes a tool selection section 211, a parameter setting section 212, and a learning tool setting section 213.

The tool selection section 211 selects a tool to be set and a tool to be used.

The parameter setting section 212 sets a rule-based tool. In the rule-based tool, the inspection is performed based on various feature amounts (contour, color, position, and the like) of the workpiece W appearing in the image.

The learning tool setting section 213 sets a tool of a learning system using a machine learning model. In the tool of the learning system, a trained model such as a discriminator is generated according to the teaching of the user, and the inspection is performed based on an output from the trained model. In accordance with this drawing, the learning tool setting section 213 includes a learning data setting section 213a and an update section 213b. The machine learning model may include a neural network.

The learning data setting section 213a sets learning data to be input to the machine learning model. The learning data includes a learning image and a teaching content. The learning image includes, for example, at least one of a non-defective product image and a defective product image. The teaching content includes label information such as “this image is a non-defective product”, “this image is a defective product” and “this portion is defective”. The label information includes information corresponding to a class into which the workpiece W is to be classified. In accordance with this drawing, the learning data setting section 213a includes a learning image selection section 213a1, a label information setting section 213a2, and a learning data generation section 213a3.

The learning image selection section 213a1 selects a learning image. For example, the learning image selection section 213a1 may have a function of presenting a learning recommendation image at the time of setting a passage count tool. Details will be described later.

The label information setting section 213a2 receives label information for displaying the learning image selected by the learning image selection section 213a1 on the GUI and using the learning image as learning data. For example, the label information setting section 213a2 receives ON registration and OFF registration at the time of setting an AI trigger tool.

The learning data generation section 213a3 generates learning data based on the learning image selected by the learning image selection section 213a1 and the window setting received by the label information setting section 213a2. For example, the learning data generation section 213a3 stores an image characteristic of the workpiece W based on the setting of the window.

The update section 213b updates parameters of the machine learning model such that the output of the machine learning model approaches an expected value according to the teaching content. The updating of the parameter may be understood as learning of the machine learning model. However, the learning of the machine learning model does not necessarily need to be performed by the user in all processes. For example, learning with a relatively large calculation amount may be completed on a vendor side before shipment of the image inspection device S, and only learning with a relatively small calculation amount may be performed on the user side before operation of the image inspection device S. In the present specification, learning performed by the vendor side before shipment is referred to as pre-shipment learning, and learning performed by the user before operation of the image inspection device S is referred to as customer learning.

For example, the machine learning model of the image inspection device S may include a feature extraction section in which customer learning is not performed and a determination section in which customer learning is performed. Note that, the feature extraction section extracts a feature amount from the image. In addition, the determination section outputs an inspection result from the feature amount.

That is, the machine learning model of the image inspection device S may include a parameter fixed portion. The parameter fixed portion is a layer in which a parameter obtained by pre-shipment learning on the vendor side is fixed, in other words, a layer in which customer learning on the user side is unnecessary. In addition, the machine learning model of the image inspection device S may include a segmentation model that facilitates customer learning on the user side.

With this configuration, it is not necessary for the user to prepare, for example, the GPU as a facility with high processing capability required for deep learning, or for the vendor to provide an advanced learning environment by the GPU or the like as a cloud service (SaaS or the like). Therefore, an introduction barrier of the image inspection device S is lowered.

As described above, the learning should be understood in a broad sense as not only referring to deep learning with a large calculation amount but also including learning with a small calculation amount, that is, the customer learning in the present specification. Note that, since the customer learning is learning with a small calculation amount, the machine learning model may be trained by a method that does not include a machine learning method.

The inspection condition setting section 220 determines an output condition of the image inspection device S, in other words, a condition of the sensor output, for example, by combining a plurality of tools.

The inspection execution section 300 executes inspection processing of the workpiece W appearing in the plurality of frame images FR and outputs the inspection result. In accordance with this drawing, the inspection execution section 300 includes a tool execution section 310 and an inspection result output section 320.

The tool execution section 310 executes a tool selected as a use target by the tool selection section 211. In accordance with this drawing, the tool execution section 310 includes a rule determination section 311 and a learning tool execution section 312.

In a case where the tool selection section 211 selects a rule-based tool as the use target, the rule determination section 311 executes the rule-based tool.

In a case where the tool selection section 211 selects the tool of the learning system as the use target, the learning tool execution section 312 executes the tool of the learning system.

The inspection result output section 320 outputs the inspection result according to the output condition set by the inspection condition setting section 220. The inspection may include image classification, abnormality detection, region segmentation, and the like.

Each of the capturing setting section 100, the inspection setting section 200, and the inspection execution section 300 may be constituted only by hardware, or may be constituted by a combination of hardware and software. In addition, each of the capturing setting section 100, the inspection setting section 200, and the inspection execution section 300 may be independent, or may be configured such that a plurality of functions is realized by one piece of hardware or software. Note that, the software can be executed by the control unit 2 (in particular, the controller 21) in which a program file and a setting file are installed.

The image inspection device S of the present configuration example can be switched between a setting mode and a driving mode. In the setting mode, for example, various parameter settings such as capturing settings, registration of a master image, and generation (learning) of a discriminator that identifies an image are performed. The identification of the image as used herein includes identification related to whether the image is a non-defective product image or a defective product image, and the image inspection device S may be configured to perform quality determination as to whether or not the workpiece W is a non-defective product or a defective product based on the identification result. In addition, in the setting mode, for example, a preliminary work for enabling the user to separate the non-defective product and the defective product in a desired product inspection is performed.

In the driving mode, the workpiece W is inspected based on the frame image FR captured at an actual site. The inspection of the workpiece W includes a number count for counting the number of workpieces W in addition to the above-described quality determination. The switching between the setting mode and the driving mode can be performed on a GUI to be described later. In addition, it is also possible to configure to automatically shift to the driving mode simultaneously with finish of the setting mode. In the driving mode, it is also possible to perform correction or change of an identification boundary by the discriminator, that is, so-called additional learning.

### (AI Trigger Tool)

Incidentally, in a case where the image inspection is performed on the moving workpiece W, it is necessary to acquire the frame image FR captured at a timing when the workpiece W becomes a desired state (position, angle, and the like) in the capturing field of view as an inspection target image.

In a photoelectric sensor generally used as a trigger sensor that outputs a trigger, it is difficult to trigger with a thin workpiece. In addition, in a case where a trigger condition is set such that a trigger is applied to a workpiece having a predetermined contour, size, or color, it is also difficult to apply a trigger to each of a plurality of types of workpieces having different contours, sizes, or colors. Further, it is also difficult to apply the trigger with a plurality of workpieces aligned without a gap. In addition, a trigger may be applied twice with an annular workpiece. Note that, some of the above problems can be solved by using a color sensor or the like. However, appropriate selection is required, and a skilled technology is required.

In addition, in recent years, there is also an example of using an image sensor to apply the trigger. In this case, for example, even in a workpiece such as a thin workpiece in which it is difficult to generate a trigger by a photoelectric sensor, when a trigger condition can be defined by a visual characteristic on a captured image, the trigger can be applied. However, since there are many workpieces whose visual characteristics on the captured image are not stable, it is difficult to set the trigger condition. For example, in the case of processing of searching for and applying the trigger to the contour of the workpiece, it is difficult to stably apply the trigger in a case where the contour of the workpiece on the captured image becomes unstable due to halation or the like. In addition, for example, even in a case where the contour is different between an OK workpiece and an NG workpiece, it is difficult to apply the trigger. Thus, a case where the image sensor can be used as a trigger generation unit is extremely limited.

On the other hand, the image inspection device S includes an AI trigger tool as one of various tools. The AI trigger tool is a tool that determines whether or not each of the plurality of sequentially acquired frame images FR is an image for which an inspection trigger is to be turned on by the machine learning model.

Note that, the AI trigger tool that generates the inspection trigger of the workpiece W appears in the frame image FR digitizes the frame image FR and compares the digitized value with a threshold TH for determining whether or not the inspection trigger is to be turned on (details will be described later). On the other hand, the AI tool that determines the non-defective product/defective product of the workpiece W shown in the frame image FR based on the frame image FR digitizes the frame image FR and compares the frame image FR with a threshold for determining the non-defective product or the defective product of the workpiece W. That is, as viewed inside the image inspection device S, the AI trigger tool can be understood as a kind of AI tool.

The trigger determination by AI is performed, and thus, trigger determination robust to halation and the like can be realized.

In addition, the image inspection device S can flexibly set the trigger condition such that the inspection trigger is output at a timing desired by the user. This point will be described in detail below.

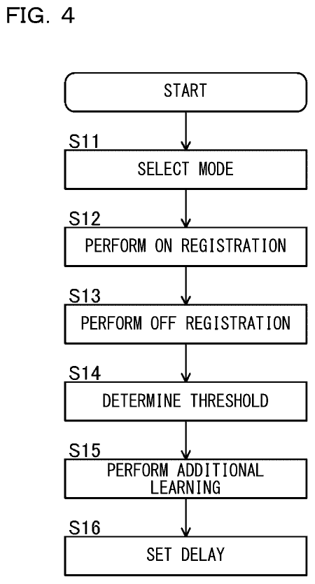

FIG. 4 is a diagram illustrating a setting flow of the AI trigger tool. An execution subject of this flow can be basically understood as the inspection setting section 200.

When this flow is started, one mode is selected from a plurality of modes (for example, standard mode, sorting mode, and passage mode) in step S11. The following description is based on the assumption that the standard mode is selected in this step. In step S12, an ON image F [Foreground] in which the workpiece W is in the detection region is selected. On the other hand, in step S13, an OFF image B [Background] in which the workpiece W is not in the detection region is selected. Note that, at least one of the ON image F and the OFF image B may be cut out from the frame image FR during live image capturing or replay reproduction. In addition, the order of steps S12 and S13 may be reversed.

In step S14, the ON image F and the OFF image B are input to the feature extraction section of the machine learning model. The feature extraction section acquires a feature amount Ff of the ON image F and a feature amount Fb of the OFF image B. In addition, in step S14, the threshold TH relative to a score SC to be compared with a score SC of the frame image FR generated by the image capturing unit 1 is determined.

The score SC is a numerical value indicating whether the frame image FR is classified into the ON image F or the OFF image B. For example, the score SC increases as the frame image FR is closer to the ON image F, and decreases as the frame image FR is closer to the OFF image B. That is, the score SC increases as a feature amount Fq acquired when the frame image FR is input to the feature extraction section becomes similar to the feature amount Ff of the ON image F, and decreases as the feature amount Fq becomes similar to the feature amount Fb of the OFF image B. Each of the feature amounts Ff, Fb, and Fq may be a feature vector of the detection region.

As described above, since the score SC may be a value that increases as the frame image FR is closer to the ON image F and decreases as the frame image FR is closer to the OFF image B, the threshold TH determined in step S14 of the present embodiment may be determined as the threshold TH relative to the score SC of the frame image FR. For example, the threshold TH may be substantially changed by changing a method for calculating the score SC based on the feature amount such that the score SC based on the feature amount Ff becomes larger than the threshold TH and the score SC based on the feature amount Fb becomes smaller than the threshold TH in a state where a fixed value is set as the threshold TH. In other words, the method for calculating the score SC may be determined so as to satisfy a relative relationship that the score SC based on the feature amount Ff is large with respect to the predetermined threshold TH and the relative relationship that the score SC based on the feature amount Fb is small. In addition, the value of the threshold TH itself may be changed based on the feature amount.

In addition, in the present embodiment, two images of the ON image F and the OFF image B are selected in step S13 and step S14, but the images may be selected such that the relative threshold TH can be determined. For example, the threshold TH defining a range of the score SC regarded as being similar to the ON image F may be determined based on the feature amount Ff extracted from the ON image F. In addition, the threshold TH defining a range of the score SC regarded as an image in a state different from the OFF image B, that is, a state including the workpiece W may be determined based on the feature amount Fb extracted from the OFF image B.

In step S15, addition selection (relearning) of at least one of the ON image F and the OFF image B is received. In step S16, a delay from the output of the inspection trigger to the actual execution of the inspection is set. However, steps S15 and S16 are not essential steps for setting the AI trigger tool.

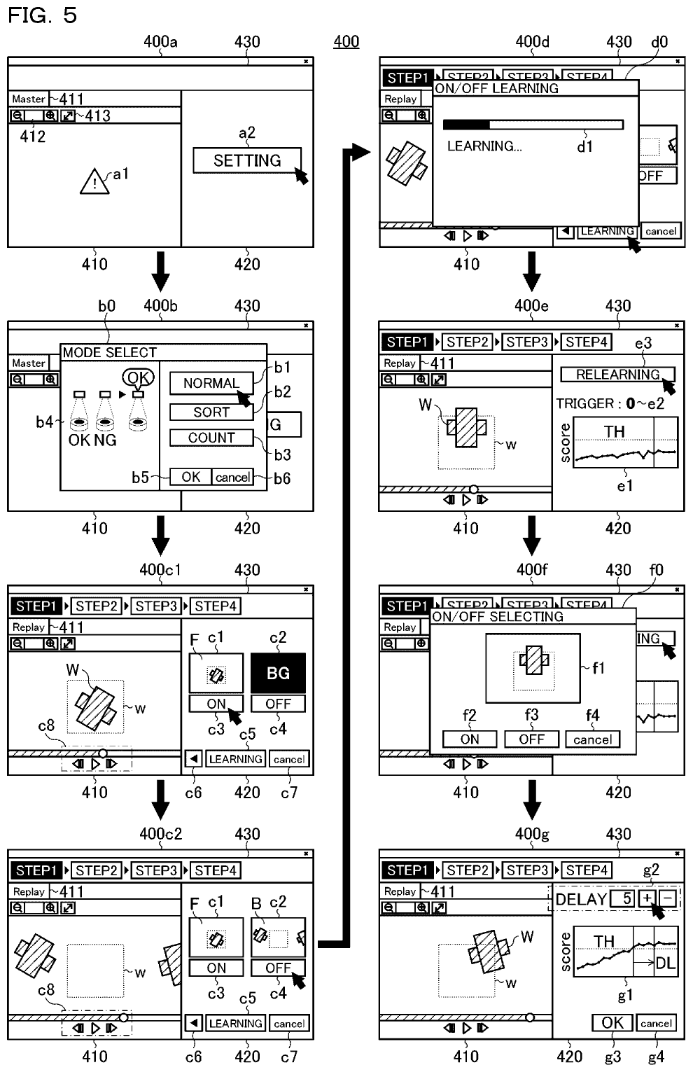

FIG. 5 is a diagram illustrating GUI transition corresponding to the setting flow illustrated in FIG. 4. When an image inspection program is executed by the PC 3, a GUI 400 (=various screens 400a to 400g) is displayed on the display device 4. The GUI 400 includes, as a basic layout, an image display region 410, an operation region 420, and a progress display region 430.

In the image display region 410, the frame image FR captured by the image capturing unit 1 and the like are displayed. In addition, the image display region 410 may be accompanied by a state display banner 411, an enlargement and reduction button 412, a maximum display button 413, and the like. In the state display banner 411, an operation state (status) of the image inspection program is briefly displayed. The enlargement and reduction button 412 and the maximum display button 413 are operated when the image displayed in the image display region 410 is enlarged or reduced and maximized, respectively.

When the image inspection device S is activated for the first time, an initial activation screen 400a (a first row in a left column) is displayed. Note that, at the time of the first activation of the image inspection device S, the image inspection program cannot be set. Thus, an alert mark a1 (or alert message) indicating that a master image is unregistered may be displayed in the image display region 410. In addition, a banner (for example, “Master”) indicating that the master image is unregistered (or is being registered) may be displayed on the state display banner 411.

In addition, for example, a setting start button a2 is displayed in the operation region 420 of the initial activation screen 400a. When the setting start button a2 is clicked (or tapped, and the same applies later), setting of the image inspection program is started. This start corresponds to the start of the setting flow illustrated in FIG. 4.

In the setting of the image inspection program, first, a mode selection screen 400b (a second row in the left column) is displayed. The mode selection screen 400b corresponds to step S11 in FIG. 4. For example, as illustrated in this drawing, a mode selection dialog b0 may be displayed on the mode selection screen 400b.

In the mode selection dialog b0, for example, a standard mode button b1, a sorting mode button b2, a passage mode button b3, a guidance b4, an OK button b5, and a cancel button b6 are displayed.

When the standard mode button b1 is clicked, the standard mode is selected. In the standard mode, the non-defective product or the defective product of the workpiece W is identified. When the sorting mode button b2 is clicked, the sorting mode is selected. In the sorting mode, the workpieces W are sorted (classified) into a plurality of classes. When the passage mode button b3 is clicked, the passage mode is selected. In the passage mode, the number of workpieces W sequentially passing through the capturing field of view of the image capturing unit 1 is counted. In the guidance b4, an outline and a schematic diagram of the mode selected by clicking among the standard mode button b1, the sorting mode button b2, and the passage mode button b3 may be displayed.

When the OK button b5 is clicked, a selection state of the mode is confirmed. On the other hand, when the cancel button b6 is clicked, the selection state of the mode is canceled and the mode selection dialog b0 is closed. The following description is based on the assumption that the standard mode is selected on the mode selection screen 400b (mode selection dialog b0).

When the standard mode is selected on the mode selection screen 400b, a first process (capturing setting), a second process (master registration), a third process (tool setting), and a fourth process (output assignment) are sequentially advanced as a setting work of the standard mode. Thereafter, in the progress display region 430 described above, each process may be displayed on a flowchart, and the process currently being executed may be highlighted. With such a configuration, the user can grasp a progress status of the setting work at a glance.

First, in the first process (capturing setting), ON and OFF setting screens 400c1 and 400c2 (a third row and a fourth row in the left column) are displayed. The ON and OFF setting screens 400c1 and 400c2 correspond to steps S12 and S13 in FIG. 4. In the operation region 420 of the ON and OFF setting screen 400c, for example, an ON image display region c1, an OFF image display region c2, an ON image registration button c3, an OFF image registration button c4, a learning start button c5, a back button c6, and a cancel button c7 may be displayed.

In addition, as illustrated in this drawing, in the first process (capturing setting), a live image (=moving image being captured) or a replay reproduction image (=recorded moving image) may be displayed in the image display region 410. In accordance with this drawing, the state display banner 411 may display a banner (for example, “Replay”) indicating that a replay reproduction image is being displayed.

At this time, in the image display region 410, for example, an image operation button c8 may be displayed. The image operation button c8 is operated when the reproducing and pausing of the replay reproduction image, rewinding and fast-forwarding buttons, frame-rewound or frame-forwarded, and the like are performed.

In a selection work of the ON image F and the OFF image B, first, a window w (=detection region) for the replay reproduction image is set. The window w may be, for example, a square. The user can designate the detection region by adjusting a position, a size, and an angle of the window w so as to surround the workpiece W appearing in the replay reproduction image.

Subsequently, images to be cut out as the ON image F and the OFF image B from the replay reproduction image are searched for by using the image operation button c8. For example, in the image display region 410 of the ON and OFF setting screen 400c1, an image obtained by capturing a state where the workpiece W is present inside the window w (=a state where the capturing trigger is to be applied) is displayed. When the ON image registration button c3 is clicked in this state, the image being displayed in the image display region 410 is selected as the ON image F. The selected ON image F is displayed in the ON image display region c1. The workpiece W appearing in the ON image F may be either the non-defective product or the defective product. In the OFF image display region c2, information indicating that the OFF image B is not selected may be displayed as illustrated in this drawing.

In addition, in the image display region 410 of the ON and OFF setting screen 400c2, an image obtained by capturing a state where the workpiece W is not present inside the window w (=a state where the inspection trigger is not to be applied) is displayed. When the OFF image registration button c4 is clicked in this state, the image being displayed in the image display region 410 is selected as the OFF image B. The selected OFF image B is displayed in the OFF image display region c2.

When the learning start button c5 is clicked after the ON image F and the OFF image B are selected, the learning of the machine learning model used in the AI trigger tool is started. When the back button c6 is clicked, the screen returns to the mode selection screen 400b described above. When the cancel button c7 is clicked, the selected state of the ON image F and the OFF image B is canceled.

When the learning of the machine learning model is started, a learning progress screen 400d (a first row in a right column) is displayed. The learning progress screen 400d corresponds to step S14 in FIG. 4. The image inspection device S (in particular, the inspection setting section 200) acquiring the feature amount Ff of the ON image F and the feature amount Fb of the OFF image B by inputting the learning images (the ON image F and the OFF image B) to the machine learning model as the learning of the machine learning model.

In addition, the threshold TH relative to the score SC to be compared with the score SC of the frame image FR generated by the image capturing unit 1 is determined. The threshold TH is determined so as to be able to discriminate whether or not the workpiece W appears inside the window w. The non-defective product or the defective product of the workpiece W is unacceptable. That is, even though the workpiece W is the defective product, the inspection trigger can be applied. In other words, it is possible to perform a series of inspection outputs in which the inspection trigger is applied regardless of whether the workpiece W appearing in the frame image FR is the non-defective product or the defective product, and the non-defective product or the defective product is determined through the image inspection. A hysteresis may be given to the threshold TH for preventing chattering of the inspection trigger.

Note that, a learning progress dialog do may be displayed on the learning progress screen 400d as illustrated in this drawing. In the learning progress dialog do, for example, a learning progress bar d1 indicating a degree of progress (0% to 100%) is displayed.

As described above, according to the machine learning using the live image or the replay reproduction image on which the workpiece W appears, the user themselves can set an appropriate trigger condition (threshold TH) without abstracting the image characteristics of the ON image F and the OFF image B and appropriately setting the trigger condition. Therefore, flexibility of user setting is improved.

In a score graph e1, a relationship between the score SC of the image displayed in the image display region 410 (particularly, the detection region divided by the window wd) and the threshold TH is displayed as a graph. According to such visualization, it is possible to visually transmit the stability of the inspection trigger to the user. For example, the user can confirm how to apply the inspection trigger by collating image aspects before and after the inspection trigger is applied while tracking the transition of the score SC in time series.

In a score graph e1, a relationship between the score SC of the image displayed in the image display region 410 (particularly, the detection region divided by the window wd) and the threshold TH is displayed as a graph. According to such visualization, it is possible to visually transmit the stability of the inspection trigger to the user. For example, the user can confirm how to apply the inspection trigger by collating image aspects before and after the inspection trigger is applied while tracking the transition of the score SC in time series.

In addition, the score graph e1 may be referred to by the user as a selection assist tool of an image suitable for additional learning. For example, in an additional image selection screen 400c of this drawing, most of the workpiece W is inside the window w, but the score SC does not reach the threshold TH. Thus, the number of triggers e2 remains “0”. When the inspection trigger is to be applied to this image, it is desirable to perform additional learning on this image as the ON image F. Conversely, when the inspection trigger is not to be applied to this image, the additional learning may be performed on this image as the OFF image B.

In addition, although not clearly illustrated in this drawing, for example, a mark indicating a peak (inflection point) of the score SC varying vertically may be given to the score graph e1. The score SC often takes a peak value at a timing when the workpiece W enters or exits the window w. Thus, with the configuration in which the mark is given, it is possible to efficiently search for the image in which the output omission of the inspection trigger occurs. In particular, when the mark given to the score SC is clicked, the screen may jump to the corresponding image and be displayed in the image display region 410. In addition, in a case where there is a plurality of learning recommendation images, each of the learning recommendation images may be displayed as a thumbnail as an additional learning candidate.

When the additional learning button e3 is clicked, the screen transitions to a confirmation screen 400f for confirming whether or not to perform additional learning on the image displayed in the image display region 410 at this point in time. An additional learning dialog f0 may be displayed on the confirmation screen 400f as illustrated in this drawing. In the additional learning dialog f0, for example, an additional image display region f1, an ON image registration button f2, an OFF image registration button f3, and a cancel button f4 may be displayed.

In the additional image display region f1, the image displayed in the image display region 410 at a point in time when the additional learning button e3 is clicked is displayed. When the ON image registration button f2 is clicked in this state, the additional learning is performed on the image being displayed in the additional image display region f1 as the ON image F. As a result, the inspection trigger is applied at a point in time when the workpiece W enters the window w to the same extent as the added image.

On the other hand, when the OFF image registration button f3 is clicked, the additional learning is performed on the image being displayed in the additional image display region f1 as the OFF image B. As a result, even though the workpiece W enters the window w to the same extent as the added image, the inspection trigger is not triggered.

Note that, the image to be used for the additional learning may be cut out from the frame image FR during live image capturing or replay reproduction.

Further, in a case where a delay DL from when the score SC exceeds the threshold TH to when the inspection trigger is actually output is set, a delay setting screen 400g is displayed. That is, in a case where the frame image FR after a predetermined number of frames with respect to the frame image FR whose score SC exceeds the threshold TH is set as a detection target image, the delay setting screen 400g is displayed. For example, a score graph g1, a delay setting tool g2, an OK button g3, and a cancel button g4 may be displayed in the operation region 420 of the delay setting screen 400g.

In the score graph g1, a relationship between the score SC of the image displayed in the image display region 410 and the threshold TH is displayed as a graph, as described above. In addition, the delay DL may be clearly indicated in the score graph g1.

The delay setting tool g2 is operated when the delay DL is set. The delay setting tool g2 may include a box for receiving direct input of the delay DL, a + button for receiving increment of the delay DL, and a − button for receiving decrement of the delay DL.

Note that, when DL=0, the inspection trigger is output without delay at a point in time when the score SC exceeds the threshold TH, and the image inspection (non-defective product or defective product determination, or the like) is performed. On the other hand, when DL>0, the inspection trigger is output several frames after the score SC exceeds the threshold TH, and the frame image FR after the several frames is treated as the detection target image. As described above, when the delay DL is set, the image inspection can be performed on an image different from the image obtained at a point in time when the score SC exceeds the threshold TH. For example, in a case where a part of the workpiece W is to be inspected, the setting of the delay DL can be effective.

When the OK button g3 is clicked, the delay DL is confirmed. On the other hand, when the cancel button g4 is clicked, the delay DL is canceled.

The above description is the outline of the GUI transition in the first process (capturing setting). Note that, although not explicitly illustrated in this drawing, in the first process (capturing setting), the capturing field of view, brightness of an image, focus, capturing interval (frame rate), and the like may be set.

After the finish of the first process (capturing setting), in the second process (master registration), the master image of the workpiece W to be determined as the non-defective product or the defective product is registered. Note that, the master image may be registered from the live image, the driving history image, or the file image. In the third process (tool setting), various settings regarding a rule-based or learning-based tool are performed. In the fourth process (output assignment), output contents (inspection result of non-defective or defective, busy result, error result, and the like) are assigned to the output ports of the inspection result output section 320.

### (Inspection Trigger)

Finally, an output operation of the inspection trigger will be described. The image inspection device S in the driving mode (in particular, the inspection execution section 300) acquires feature amounts Fq1 and Fq2 from frame images FR1 and FR2 sequentially generated by the image capturing unit 1. The detection trigger is output at a point in time when the score SC of the frame image FR1 calculated based on the feature amount Fq1 is lower than the threshold TH and the score SC of the frame image FR2 calculated based on the feature amount Fq2 is equal to or larger than the threshold TH, that is, at a point in time when Fq1<TH<Fq2.

Note that, the image inspection device S (in particular, the inspection execution section 300) preferably executes the inspection processing on the frame image FR2 at a point in time when the score SC is equal to or greater than the threshold TH. With such a configuration, for example, the image inspection can be performed without any trouble even in a case where the workpiece W is out of the capturing field of view in a frame image FR3 generated immediately after the frame image FR2.

### OTHERS

Note that, in addition to the embodiment, various modifications can be made to various technical characteristics disclosed in the present specification without departing from the spirit of the technical creation. That is, it should be considered that the embodiment is illustrative in all respects and not restrictive. In addition, the technical scope of the invention is defined by the claims, and should be understood to include all modifications falling within the meaning and scope equivalent to the claims.

What is claimed is:

1. An image inspection device comprising:
an image capturing section that continuously captures a capturing field of view to generate a plurality of frame images aligned in time series;
an inspection execution section that executes inspection processing of an object appearing in the plurality of frame images by a machine learning model to output an inspection result; and
an inspection setting section that performs setting of the inspection execution section,
wherein the machine learning model includes a feature extraction section that extracts a feature amount from the frame images, and a determination section that outputs the inspection result from the feature amount,
the inspection setting section
receives selection of a first image, and
determines a score calculation method based on a first feature amount extracted from the selected first image such that a score based on the first feature amount satisfies a predetermined relative relationship with respect to a threshold, and
the inspection execution section
extracts the feature amount from a first frame image and a second frame image continuous with the first frame image, as the plurality of frame images, and
outputs an inspection trigger when it is determined that the threshold is present between a first score based on a feature amount extracted from the first frame image and a second score based on a feature amount extracted from the second frame image.

2. The image inspection device according to claim 1,
wherein the inspection setting section
receives selection of an image in which the object is in a detection region as the first image and a second image in which the object is not in the detection region, and
determines the threshold to be compared with the score indicating whether the frame image is classified into the first image or the second image based on the first feature amount and a second feature amount extracted from the second image.

3. The image inspection device for an image according to claim 2,
wherein the inspection setting section determines a relative threshold with respect to a score such that the score of the frame image similar to the first image is higher than the score of the frame similar to the second image, and
the inspection execution section acquires a third feature amount and a fourth feature amount from a first frame image and a second frame image generated as the plurality of frame images, respectively, and outputs an inspection trigger at a point in time when a first score of the first frame image calculated based on the third feature amount extracted from the first frame image is lower than the threshold and a second score of the second frame image calculated based on the fourth feature amount extracted from the second frame image consecutive to the first frame image is equal to or greater than the threshold.

4. The image inspection device according to claim 1, wherein the inspection execution section executes the inspection processing on the second frame image.

5. The image inspection device according to claim 1,
wherein the inspection setting section
displays an image during live image capturing or during replay, and
receives selection of the image to be displayed as at least one of the first image and the second image.

6. The image inspection device according to claim 1, further comprising a GUI that displays the score as a graph.

7. An image inspection device comprising:
an image capturing section that continuously captures a capturing field of view to generate a plurality of frame images aligned in time series;
an inspection execution section that executes inspection processing of an object appearing in the plurality of frame images by a machine learning model to output an inspection result; and
an inspection setting section that performs setting of the inspection execution section,
wherein the machine learning model includes a feature extraction section that extracts a feature amount from the frame image, and a determination section that outputs the inspection result from the feature amount,
the inspection setting section
receives selection of a first image, and
determines a threshold for a score based on a first feature amount extracted from the selected first image, and
the inspection execution section
extracts the feature amount from a first frame image and a second frame image continuous with the first frame image, as the plurality of frame images, and
outputs an inspection trigger when it is determined that the threshold is present between a first score based on a feature amount extracted from the first frame image and a second score based on a feature amount extracted from the second frame image.
